(19) United States
(12) Patent Application Publication
(10) Pub. No.: US 2004/0246304 A1
(43) Pub. Date: Dec. 9, 2004

(54) Ink tank

(75) Inventors: Wataru Takahashi, Kanagawa (JP); Yasuo Kotaki, Kanagawa (JP); Masanori Takenouchi, Kanagawa (JP); Masashi Ogawa, Kanagawa (JP); Hiromasa Amma, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/859,214

(22) Filed: Jun. 3, 2004

(30) Foreign Application Priority Data
Jun. 6, 2003 (JP) 2003-162933

(51) Int. Cl. B41J 2/14

(52) U.S. Cl. 347/49; 347/86

(57) ABSTRACT

An ink jet cartridge and an ink tank are provided which can prevent an inappropriate ink tank from being mounted on the mounting portion of the tank holder. To this end, the tank holder has a tank mounting portion on which the ink tank is mounted. The tank mounting portion has a raised portion and the ink tank is formed with a notched portion. Moving the ink tank in a roughly pivotal motion by engaging the notched portion over the raised portion can connect the ink supply ports to the ink introduction portions. Now the mounting process is complete.

This application claims priority from Japanese Patent Application No. 2003-162933 filed Jun. 6, 2003, which is incorporated hereinto by reference.

### BACKGROUND OF THE INVENTION

1. Field of the Invention

The present invention relates to an ink tank containing ink for use in an ink jet printing apparatus and also to an ink jet cartridge comprising the ink tank and a tank holder for removably holding the ink tank. More particularly it relates to a method of preventing an erroneous mounting of the ink tank.

2. Description of the Related Art

In currently available ink jet printing apparatus, there is a trend to adopt an ink refill system that simplifies an ink refilling process not by integrating an ink jet print head with an ink tank but by removably mounting the ink tank on a tank holder having the ink jet print head so that the ink tank, after ink contained therein has been used up, can be replaced with a new ink tank.

Ink jet printing apparatus using this type of ink refill system are known to use ink tanks such as shown in FIGS. 9A-9C to FIG. 13 (see U.S. Pat. No. 2,801,148).

FIG. 9A and FIG. 9B are perspective views of conventional ink tanks, and FIG. 9C is a plan view of a conventional tank holder. FIGS. 10A-10D are explanatory vertical side views showing a conventional process of mounting the ink tank onto the tank holder.

An ink tank 2a shown in FIG. 9A is one (also referred to as a multicolor ink tank) accommodating multiple color inks, such as yellow, cyan and magenta, independently of each other. This multicolor ink tank has three ink supply ports 3a, 3b, 3c (these ink supply ports may generally be represented by a reference number 3) formed in its bottom for supplying associated color inks to the print head.

An ink tank 2b shown in FIG. 9B is one (also referred to as a single color ink tank) accommodating a single color ink, such as black ink. This single color ink tank 2b has an ink supply port 3d formed in its bottom for supplying ink contained therein to the print head.

A tank holder 8 can be mounted to and dismounted from a carriage of the printing apparatus and has an ink jet print head (simply referred to as a print head) 1 secured to the bottom thereof to eject a plurality of inks (in this example, four color inks). The tank holder 8 also has tank mounting portions 10a, 10b on which to mount these ink tanks. One of the tank mounting portions, 10a, has formed in its bottom three ink introduction portions 11a, 11b, 11c communicating with the print head. The other tank mounting portion 10b has one ink introduction portion lid communicating with the print head. Ink introduction portions 11a, 11b, 11c and lid may generally be represented by a reference number 11. The ink introduction portions 11a-lld are constructed to tightly connect to the ink supply ports 3a-3d of the ink tanks 2a, 2b mounted on the associated tank mounting portions. Thus, inks are supplied from the ink supply ports 3a, 3b, 3c, 3d of the ink tanks 2a, 2b through the ink introduction portions 11a-11d into the associated print heads which eject the inks from their nozzles by driving ejection energy generation elements provided one in each nozzle. Commonly used as the ejection energy generation elements are electrothermal transducer elements such as heaters and electromechanical transducer elements such as piezoelectric elements.

The ink tanks are mounted on the ink jet print heads in a procedure shown in FIG. 10A to FIG. 10D. Here, an example case of mounting the multicolor ink tank 2a on the tank holder 8 will be explained.

First, as shown in FIG. 10A, the ink tank 2a, held in its tilted attitude, is inserted toward the tank mounting portion 10a of the tank holder 8. Then, as shown in FIG. 10B, the ink tank 2a is inserted in a roughly pivotal motion until a corner portion 15 at a top of a rear side (upper left corner in the figure) of the ink tank 2a engages a biasing portion 13 of the tank holder 8. As a result, the ink tank 2a is locked in the tank holder 8 and at the same time the ink supply ports 3 tightly connect and communicate to the ink introduction portions 11. Now the ink tank mounting procedure is completed (see FIG. 1° C. and FIG. 10D). When the tank holder 8 is mounted on the carriage of the printing apparatus, an F side shown in FIG. 1° C. represents a front side of the printing apparatus and a surface of the ink tank 2a whose upper end portion tilts downwardly as it is mounted is taken as the front side.

When the ink tank 2a mounted on the tank holder 8 as described above is to be taken out, the ink tank needs only to be pulled in a roughly pivotal motion in a direction opposite the direction of mounting (clockwise in the figure) to be unlocked from the tank holder 8.

FIG. 11A is a schematic, vertical cross section of another conventional ink tank 20, and FIG. 11B is a bottom view of the ink tank 20.

As shown in FIG. 11A and FIG. 11B, a tank case 17 of the ink tank 20 has an atmospheric communication port 21 formed in a top wall thereof. In the tank case 17 an ink holding member 18 is installed. A bottom wall of the tank case 17 is formed with an ink supply port 23 at a position off-centered toward the rear side (in the figure, to the left side). An ink draw-out member 19 is located at a position so as to close the ink supply port 23.

FIG. 12A is a vertical side cross section of the ink tank 20 and the tank holder 8, with the ink tank 20 taken out of the tank holder 8. FIG. 12B shows the state of the ink tank 20 as it begins to be mounted onto the tank holder 8. FIG. 13 shows an inner state of the ink tank 20 after the ink tank 20 is mounted on the tank holder 8.

When the ink tank 20 is installed into the tank holder 8, it is inserted in a tilted attitude into the tank holder 8 so that an upper end of an ink tank guide portion 12 comes into the ink supply port 23. Then, the ink tank 20 is pushed in a roughly pivotal counterclockwise motion until the ink tank rests vertical as shown in FIG. 13. Now the mounting process is complete.

When the tank mounting process is complete, the ink supply port 23 of the ink tank 20 receives the ink tank guide portion 12, with the upper end of the ink tank guide portion protruding into the ink tank 20 to push the ink draw-out member 19 upward. As a result, an ink path is established between the ink holding member 18 and the ink jet print head, supplying ink to the print head.

In ink jet printing apparatus of recent years, it is proposed that a memory device storing information on an ink volume in the ink tank is held on a side surface of the ink tank to improve functions of the printing apparatus and the ink tank (Japanese Patent Application Laid-open No. 2001-253087). In this ink jet printing apparatus, when the ink tank is mounted on the tank holder, a head side contact provided on the tank holder is electrically connected to a contact in the memory device on the ink tank side, causing data stored in the memory device to be read out for use in the control of printing operation.

In an ink jet printing apparatus in which the ink tank is removably mounted on the tank holder as described above, it is necessary to prevent the print head from being supplied an ink different from an intended ink. Thus, when an empty ink tank is replaced with a new one, it must be ensured that the replacement ink tank that is going to be mounted contains the same ink that was contained in the spent tank.

With the conventional ink tanks, however, since different inks are accommodated in the ink tanks having the same external structure, there is a possibility of a user inadvertently installing an ink tank containing an unintended ink onto the tank mounting portion.

In that case, not only can an appropriate image forming not be performed, but new problems also arise that an ink remaining in the print head mixes with an ink supplied from the newly installed ink tank and that ejection failures occur with nozzles. Depending on circumstances, the print head replacement may become unavoidable. Since the ink tank 2a of FIG. 9A and the ink tank 2b of FIG. 9B are completely different in outer shape, there is little chance that the ink tank 2b may be installed onto the tank mounting portion 10a of the tank holder 8 and the ink tank 2a onto the tank mounting portion 10b. However, among those ink tanks having the same shapes as the ink tanks 2a, 2b, there are a variety of ink tanks that contain inks with different components and colors. So, there is an ample chance for erroneous mounting. Further, there are also ink jet printing apparatus that employ a construction in which the tank holder is mounted with a plurality of ink tanks of the same shapes. In that case, the erroneous mounting of ink tank becomes more significant.

In ink tanks having memory devices such as shown in the aforementioned cited reference (Japanese Patent Application Laid-open No. 2001-253087), in the event of an erroneous mounting, an unintended memory device is connected to the ink jet printing apparatus side, giving rise to a possibility that the memory device, the print head and the printing apparatus may be damaged or erroneous operations may result. Furthermore, mounting an unintended ink tank may mechanically break the head side contact on the tank holder 8.

If the ink supply port 3 is formed at a position deviated from a center of the bottom surface of the ink holding member 18, as in the ink tank shown in FIG. 11A and FIG. 11B, the ink holding member 18 pushed up together with the ink draw-out member 19 by the ink tank guide portion 12 may pivot as shown in FIG. 13. When the ink holding member 18 shifts its attitude inside the tank case 17 as described above, a contact portion between the ink draw-out member 19 and the ink holding member 18 may change, reducing a contact area of these members. In that case, since the ink path from the ink holding member 18 to the ink draw-out member 19 becomes narrow, an ink supply may become insufficient particularly in a print head of a printing apparatus of recent years which has a fast printing speed, making it impossible to perform a stable printing operation. It is thus desired that the ink holding member 18 be kept in contact uniformly with the entire surface of the ink draw-out member 19, as shown in FIG. 11A.

### SUMMARY OF THE INVENTION

An object of this invention is to provide an ink jet cartridge and an ink tank which can prevent an inappropriate ink tank from being mounted on the mounting portion in the tank holder and which can form a correct ink supply path between the mounted ink tank and a print head.

To achieve the above objective, this invention provides an ink tank to be installed into a tank holder, wherein the tank holder has an ink tank mounting portion, an ink introduction portion arranged in a bottom surface of the ink tank mounting portion and communicating with an ink jet print head, and a raised portion protruding from the bottom surface of the ink tank mounting portion; the ink tank comprising: an ink supply port arranged in a bottom surface of the ink tank for drawing out ink; and a notched portion arranged at a front edge portion of the bottom surface of the ink tank, communicating to the bottom surface and a front surface of the ink tank, and corresponding to the raised portion of the tank holder; wherein the ink tank is mounted onto the tank holder, with the front edge portion of the bottom surface of the ink tank working as roughly a pivotal center.

In an ink jet cartridge comprising a tank holder having an ink introduction portion communicating with the ink jet print head and an ink tank removably mounted on the tank holder, the tank holder is provided with a raised portion for an erroneous mounting prevention and the ink tank is provided with a notched portion that matches the raised portion. This construction ensures that, only when an appropriate ink tank that matches the tank holder is installed, does the notched portion fit over the raised portion of the tank holder. This prevents an erroneous mounting of an ink tank that does not match the tank holder. It is therefore possible to supply a correct ink at all times from the ink tank to the print head, thus optimizing and stabilizing an image forming process. Particularly when an ink tank having a memory device storing predetermined information is used, it is possible to eliminate a danger that an ink jet printing apparatus may be undesirably operated or damaged by wrong information being sent to the printing apparatus as a result of an erroneous mounting of a wrong ink tank. This arrangement secures a reliability of the printing apparatus and at the same time offers expanded functions of the ink tank realized by the memory device.

Further, in a construction in which the ink supply port is provided in the bottom of the ink tank at a position deviated from a bottom center, a support member for supporting the ink holding member is formed in a tank case at a position deviated from the bottom center in a direction opposite the ink supply port. With this arrangement, if the ink draw-out member is pushed by the ink introduction member and presses the ink holding member, the state of engagement between the ink draw-out member and the ink holding member can be kept from deteriorating, thus assuring a stable supply of ink to the ink jet print head and improving reliability.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1A is a perspective view showing a front surface and a bottom surface of a multicolor ink tank in a first embodiment of this invention;

FIG. 1B is a side view of the multicolor ink tank in the first embodiment of this invention;

FIG. 1C is a perspective view showing a back surface and a bottom surface of the multicolor ink tank in the first embodiment of this invention;

FIG. 2A is a perspective view showing a front surface and a bottom surface of a single color ink tank in the first embodiment of this invention;

FIG. 2B is a rear view of the single color ink tank in the first embodiment of this invention;

FIG. 3A is a perspective view of a tank holder in the first embodiment of this invention;

FIG. 3B is a plan view of the tank holder in the first embodiment of this invention;

FIG. 4A to FIG. 4D are explanatory, vertical cross-sectional side view of an ink jet cartridge in the first embodiment of this invention, showing a process of mounting an ink tank onto a tank mounting portion of the tank holder;

FIG. 5A is a perspective view showing a front surface and a bottom surface of a multicolor ink tank in a second embodiment of this invention;

FIG. 5B is a front view of the multicolor ink tank in the second embodiment of this invention;

FIG. 5C is a bottom view of the multicolor ink tank in the second embodiment of this invention;

FIG. 5D is a vertical cross-sectional side view of the multicolor ink tank in the second embodiment of this invention;

FIG. 5E is an enlarged cross-sectional view taken along the line VE-VE of FIG. 5C;

FIG. 6A is a perspective view showing a front surface and a bottom surface of a single color ink tank in the second embodiment of this invention;

FIG. 6B is a front view of the single color ink tank in the second embodiment of this invention;

FIG. 6C is a bottom view of the single color ink tank in the second embodiment of this invention;

FIG. 6D is a vertical cross-sectional side view of the single color ink tank in the second embodiment of this invention;

FIG. 6E is an enlarged cross-sectional view taken along the line VIE-VIE of FIG. 6C;

FIG. 7A is an explanatory, vertical cross-sectional side view showing an ink holding member before the ink tank is mounted on the tank holder;

FIG. 7B is an explanatory, vertical cross-sectional side view showing an ink holding member after the ink tank is mounted on the tank holder;

FIG. 8A is a perspective view of another multicolor ink tank in the first and second embodiment of this invention;

FIG. 8B is a perspective view of another single color ink tank in the first and second embodiment of this invention;

FIG. 9A is a perspective view of a conventional multicolor ink tank;

FIG. 9B is a perspective view of a conventional single color ink tank;

FIG. 9C is a plan view of a conventional tank holder;

FIG. 10A to FIG. 10D are vertical cross-sectional side views showing a process of mounting the conventional ink tank on the tank holder;

FIG. 11A is a vertical cross-sectional side view schematically showing another conventional ink tank;

FIG. 11B is a bottom view schematically showing the conventional ink tank of FIG. 11A;

FIG. 12A is a vertical cross-sectional side view of the conventional ink tank and tank holder, with the ink tank removed from the tank holder;

FIG. 12B is a vertical cross-sectional side view of the conventional ink tank and tank holder when the tank begins to be mounted onto the tank holder; and

FIG. 13 is a vertical cross-sectional side view showing an inner state of the conventional ink tank when the ink tank is mounted on the tank holder.

### DETAILED DESCRIPTION OF PREFERRED EMBODIMENTS

Now, embodiments of this invention will be described by referring to the accompanying drawings.

(First Embodiment)

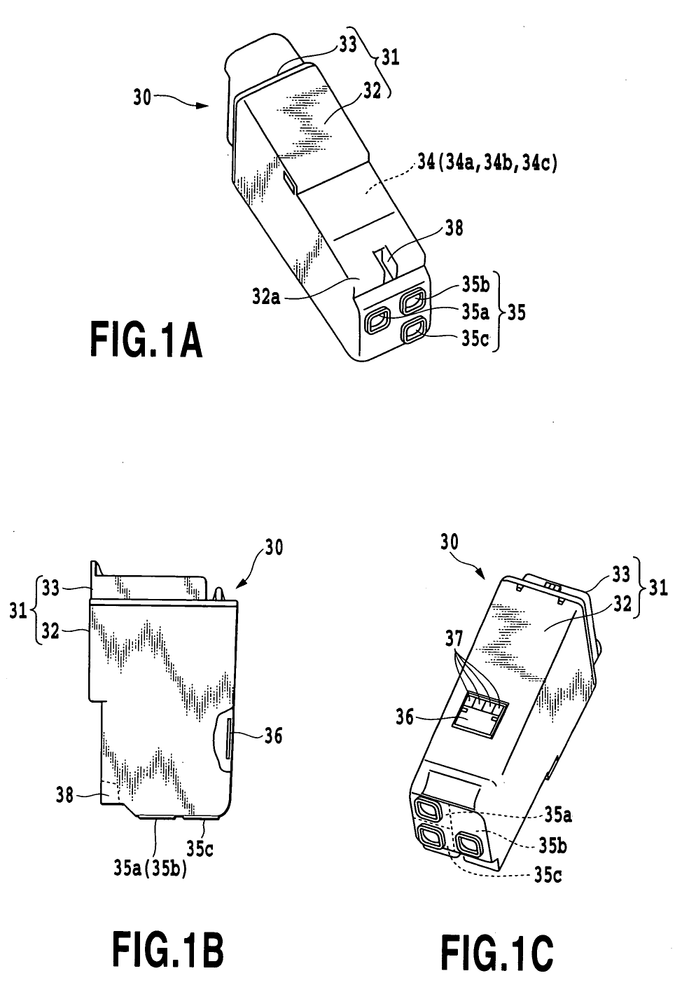

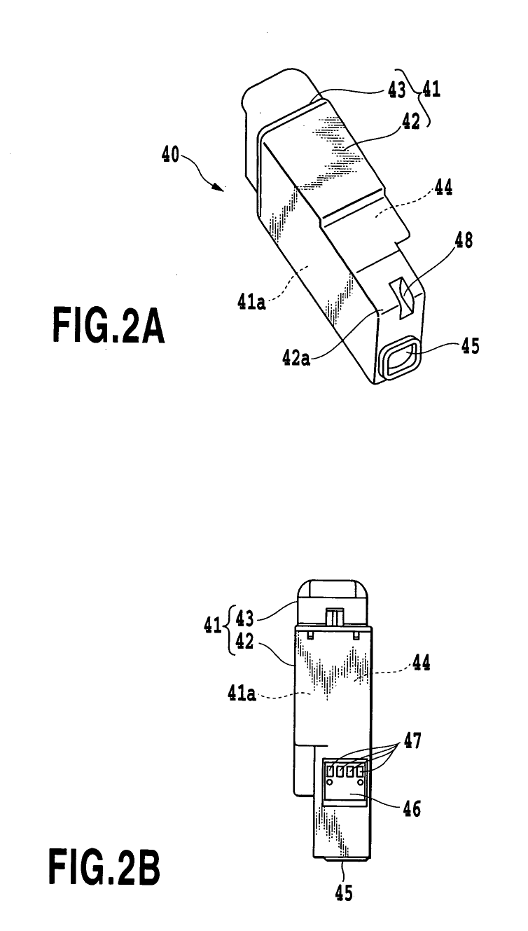

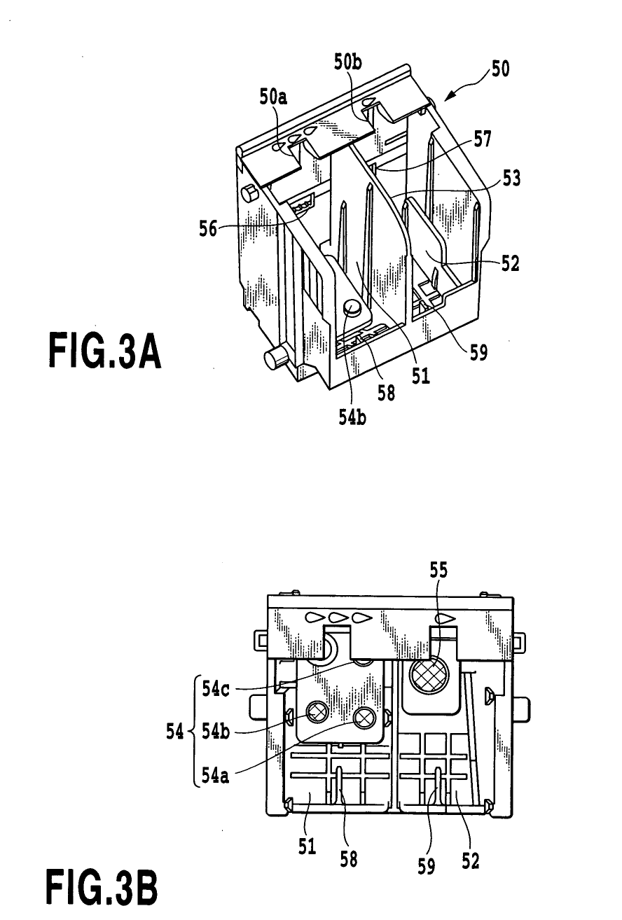

An ink cartridge in the first embodiment of this invention comprises a tank holder shown in FIG. 3A and FIG. 3B and ink tanks shown in FIGS. 1A-1C and FIGS. 2A and 2B. These are constructed as follows.

FIG. 1A is a perspective view showing a front surface and a bottom surface of one ink tank in the first embodiment of this invention, FIG. 1B is a side view of the ink tank, and FIG. 1C is a perspective view showing a back surface and a bottom surface of the ink tank.

The ink tank 30 shown here comprises mainly a tank body 31 and an ink holding member 34 accommodated in the tank body. The tank body 31 has a tank case 32 shaped like a cuboid and having an opening at its top end and a cover 33 that closes the opening of the tank case 32. The tank body 31 is shaped like a rectangular parallelepiped. The tank body 31 has three ink supply ports 35a, 35b, 35c (these ink supply ports may also be represented by a reference number 35) formed at its bottom, as shown in FIG. 1A and FIG. 1B. Inside the tank body 31 three independent ink accommodation portions 31a, 31b, 31c are formed which are separated from each other by partition walls. The ink accommodation portions accommodate ink holding members 34 (34a, 34b, 34c) that absorb and hold different color inks, such as yellow, cyan and magenta inks. At the bottom of the ink accommodation portions 31a, 31b, 31c are arranged three ink supply ports 35a, 35b, 35c, one for each ink accommodation portion. Each of the ink accommodation portions 31a, 31b, 31c has an atmosphere communication port (not shown) formed at its top.

The tank body 31 has secured to its back surface a memory device 36 that stores information, such as a volume of ink held in each ink holding member and an ID number identifying the ink tank. On the surface of the memory device 36 is provided a contact pad 37 for electric connection between the memory device and an external device.

The tank body 31 has a notched portion 38 formed in a part of an edge portion 32a on the front surface thereof. The notched portion 38 is shaped like a slit opening in two directions to extend from a part of the front surface to a part of the bottom surface. This notched portion 38 is adapted to fit over a raised portion formed on the tank holder described later.

An ink tank 40 shown in FIG. 2A and FIG. 2B is a single color ink tank holding a single color ink (for instance, black ink). The single color ink tank 40, as with the ink tank 30, comprises a cuboid tank body 41 having a tank case 42 and a cover 43, a single ink holding member 44 accommodated in the tank body 41, and a memory device 46 having a contact pad 47. The single color ink tank 40 also has a notched portion 48 formed in an edge portion 42a at a lower front part thereof. This ink tank 40, because it contains a single color ink, differs from the multicolor ink tank 30 in that it is formed slightly narrower than the multicolor ink tank 30 and that a single ink supply port 45 is formed in the bottom of the tank case. The memory devices 36, 46 provided to the ink tanks 30, 40 are arranged at positions higher than the notched portions 38, 48 formed in the front surface of the ink tanks.

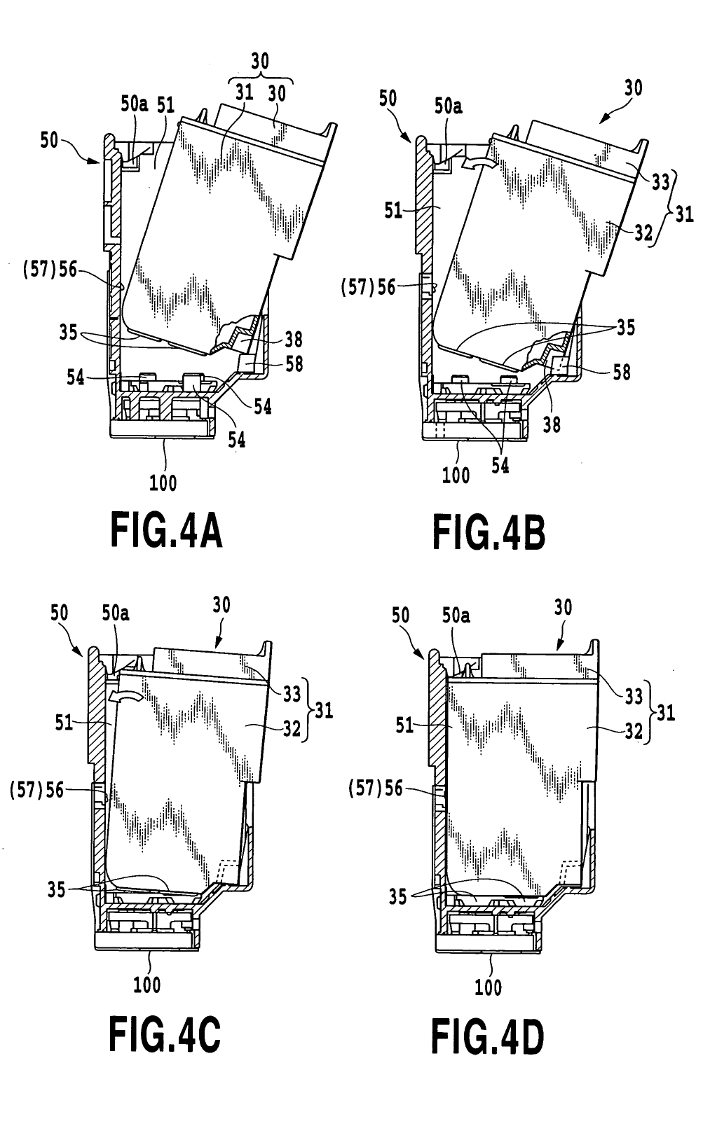

FIG. 3A and FIG. 3B illustrate a tank holder 50 in which the ink tanks 30, 40 are removably installed. The tank holder 50 is shaped like a container that opens at the front and top. The tank holder 50 has secured to its bottom an ink jet print head 100 that ejects ink contained in the ink tanks (see FIG. 4A to FIG. 4D). In this embodiment, the tank holder 50 is removably mounted on a carriage of the printing apparatus.

The tank holder 50 has its inner space divided by a separation wall 53 erected parallel to and between the left and right side walls thereof to form left and right tank mounting portions 51, 52 in which the ink tanks 30, 40 are installed. Of the two tank mounting portions 51, 52, one tank mounting portion 51 is intended to receive the multicolor ink tank 30. The bottom of the tank mounting portion 51 is formed with three ink introduction portions 54a, 54b, 54c communicating with the print head 100. The other tank mounting portion 52 is intended to receive the single color ink tank 40. The bottom of the tank mounting portion 52 is formed with one ink introduction portion 55 communicating with the print head.

At an upper part of the rear wall of each tank mounting portion 51, 52 there is a connector pin 56, 57 that presses against the contact pad 37, 47. These connector pins 56, 57 are formed of a resilient metal plate, have a springlike elasticity and form a so-called compression type connector. Thus, when or immediately before the ink tank 30, 40 is installed in the tank mounting portion 51, 52, the connector pin 56, 57 is pressed against the contact pad 37, 47 of the memory device 36, 46 and deformed. The connector pin 56, 57 is therefore kept in stable connection with the contact pad 37, 47. With the tank holder mounted on the carriage of the ink jet printing apparatus and connected through the carriage to a control system of the printing apparatus, the ink tanks are installed into the tank holder for electric connection with the control unit of the printing apparatus and with the memory devices 36, 46.

At the front part of each tank mounting portion 51, 52, an inwardly protruding riblike raised portion 58, 59 is formed. The raised portion 58, 59 is formed in such a shape or at such a position that it fits into the associated notched portion 38, 48 formed in the ink tank only when the inserted ink tank is the one intended for the tank mounting portion 51, 52, i.e., the ink tank contains the correct ink to be supplied to the ink introduction portion. That is, the raised portions 58, 59 formed in the tank mounting portions 51, 52 are formed at different positions with respect to the ink introduction portions 54, 55 or in different shapes. So, if the ink tank 30, 40, inserted into the tank mounting portion 51, 52 to connect the ink supply port 35, 45 to the associated ink introduction portion 54, 55, is the correct one containing the ink intended to be supplied to the ink introduction portion 54, 55, then the notched portion 38, 48 of the ink tank 30, 40 completely fits over the raised portion 58, 59 allowing the ink tank to be installed into the mounting portion. If on the other hand the ink tank 30, 40 contains other than the intended ink to be supplied to the ink introduction portion 54, 55, the notched portion fails to fit over the raised portion 58, 59 and abuts against the bottom of the ink tank, blocking the insertion of the ink tank.

FIGS. 4A-4D illustrate a process of mounting the ink tank 30 into the tank mounting portion 51 of the tank holder 50 in the ink jet cartridge of the above construction.

In the mounting process, the ink tank 30 is first tilted and inserted into the tank holder 50 diagonally from above, with the ink supply ports 35 formed at the bottom of the ink tank 30 directed toward the ink introduction portions 54 of the tank holder 8, as shown in FIG. 4A. At this time, if the ink tank 30 does not have the notched portion 38 or the notched portion 38 is formed in other than the shape or at other than the position that corresponds to the raised portion 58, the raised portion 58 of the tank holder 50 abuts against the outer surface (e.g., bottom surface) of the ink tank 30, blocking the ink tank 30 from being installed. The notched portion 38 is formed at a lower part of the front surface of the ink tank 30, which, among the portions of the ink tank, is the first to be inserted into the tank holder 50. Therefore, before the ink supply ports 35 and the contact pad 37 connect to the ink introduction portions 54 and the connector pin 56, the user can decide whether the ink tank being inserted is the correct one.

With this construction, it is possible to prevent the ink jet print head and the printing apparatus from being damaged, as they would otherwise be if an improper ink tank were mounted connecting a wrong memory device 36 to the printing apparatus. This construction can also avoid a wrong ink being supplied to the ink jet print head, as would occur if an improper ink tank were mounted.

If the ink tank 30 being installed into the tank mounting portion 51 of the tank holder 50 is a proper one, the notched portion 38 of the ink tank 30 fits over the raised portion 58 of the tank holder 50. In this state, the ink tank 30 is pushed in a roughly pivotal motion, as indicated by an arrow of FIG. 4B, until it reaches a vertical mounted position as shown in FIG. 4D where the upper surface portion of the cover 33 is locked by a locking portion 50a of the tank holder 50. Now the mounting of the ink tank 30 is complete. To dismount the ink tank 30 from the tank holder 50, the ink tank 30 needs to be pulled in a roughly pivotal motion in a direction opposite the arrow to unlock the ink tank from the locking portion 50a of the tank holder 50.

As described above, in this embodiment the ink tank 30 is mounted to and dismounted from the tank holder 50 by pushing or pulling it in a roughly pivotal motion. Since the notched portion 38 in the ink tank 30 opens in two directions covering a part of the front surface and a part of the bottom surface, a smooth mounting motion of the ink tank is assured by fitting the raised portion 58 of the tank holder 50 into the notched portion 38 and then pushing the tank in a roughly pivotal motion with the engaged portion as a fulcrum. That is, not only do the notched portion 38 and the raised portion 58 of this embodiment make it possible to decide in an initial stage of the ink tank mounting process whether the ink tank 30 is an appropriate one or not, but they also assure a smooth mounting of the ink tank 30.

The ink supply ports 35 and the ink introduction portions 54 are connected together immediately before the ink tank 30 is locked in its mounted position (immediately before the mounting process is complete). The contact pad 37 of the memory device 36 on the ink tank 30 is also connected to the connector pin 56 of the tank holder 50 immediately before the ink tank 30 is locked in its mounted position. It is noted, however, that their connection timing varies depending on the vertical position of the contact pad 37 on the back surface of the ink tank 30 and that of the connector pin 56.

Since the ink tank 30 is pushed or pulled in a roughly pivotal motion about an engaged portion, as a fulcrum, between the notched portion 38 and raised portion 58, the distance between the back surface of the ink tank 30 and the rear wall of the tank holder becomes narrower toward the bottom of the tank. The lowermost part of the back surface of the ink tank 30 in particular has almost no gap relative to the rear wall of the tank holder 50 when the ink tank 30 begins its pivotal motion. The connector pins 56, 57 protrude from the rear wall of the holder so that as they are pressed against the contact pad 37, they are elastically deformed for secure contact.

Therefore, if the contact pad 37 of the memory device 36 is arranged at the lowermost part of the back surface of the ink tank 30, there is a possibility that the memory device 36 and the connector pin 56 may be connected when or immediately after the ink tank 30 starts pivoting, as shown in FIG. 4B. If that happens, the memory device 36 is electrically connected to the printing apparatus when the ink supply ports 35 are not yet connected to the ink introduction portions 54.

If at this time the user enters a print operation command, the control system of the printing apparatus decides that the ink tank 30 is already installed and starts a printing operation. However, since the ink supply ports 3 are not connected to the ink introduction portions 54, no ink is supplied to the ink jet print head, resulting in abnormal printing.

To avoid such a trouble, this embodiment has the contact pad 37 of the memory device 36 arranged on the back surface of the ink tank 30 at a position higher than the notched portion 38 that functions as a pivotal fulcrum. With this arrangement, in an initial stage of the mounting process, the contact pad 37 and the connector pin 56 have not contacted each other yet, as shown in FIG. 4B. Immediately before the ink tank 30 is secured to the tank holder 8, is the contact pad 37 connected to the connector pin 56. It is desired that the contact between the contact pad 37 and the connector pin 56 be set to take place as close to the completion of the mounting of the ink tank as possible and that, since the memory device 36 is to make an electrical contact, measures be taken to keep it out of contact with ink. Considering these, the contact pad 37 is preferably arranged at as high a position on the ink tank as possible. However, the positions of the memory device 36 and the contact pad 37 may be set as required by their relations with surrounding electric parts.

While an example case of installing the multicolor ink tank 30 into the tank holder 50 has been described in this embodiment, the similar effect to that of the ink tank 30 can also be produced in the single color ink tank 40 of FIG. 2A and FIG. 2B by the action of the notched portion 48 and the raised portion of the tank holder 50. The similar considerations to those taken in the ink tank 30 can also be taken in the relation between the contact pad 47 of the memory device 46 and the connector pin 56 of the tank mounting portion 52.

(Second Embodiment)

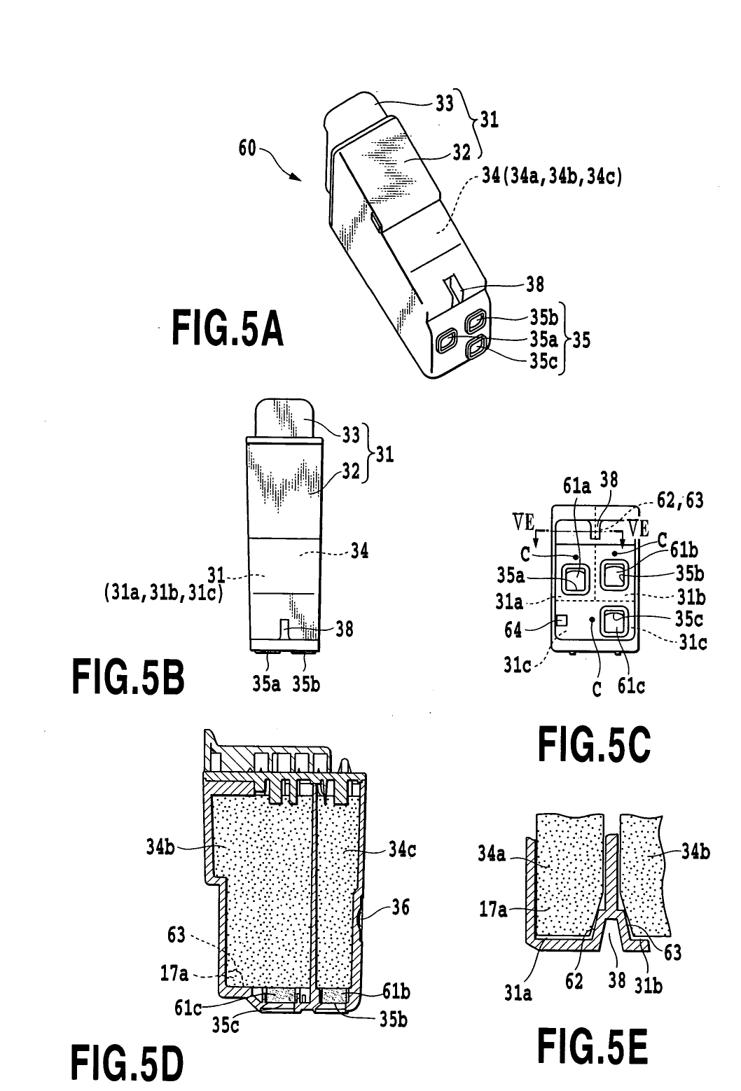

Next, the second embodiment of this invention will be described by referring to FIGS. 5A-5E, FIGS. 6A-6E and FIGS. 7A-7B. In these figures, components identical with or corresponding to those of the first embodiment are given like reference numbers and their explanations are omitted.

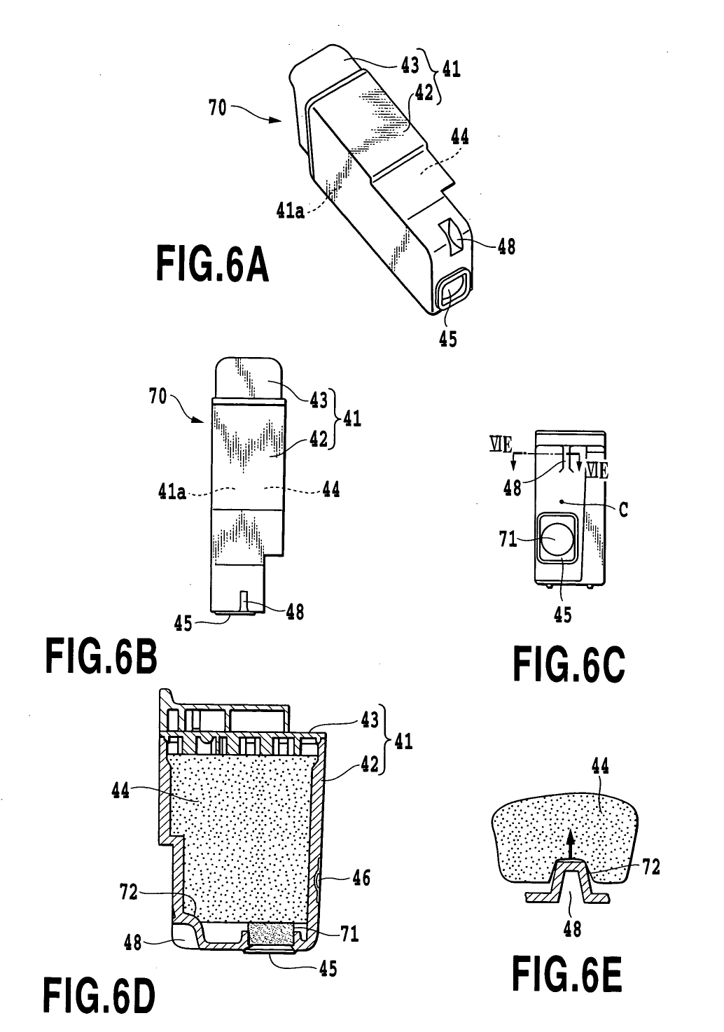

An ink cartridge in the second embodiment of this invention comprises a tank holder shown in FIG. 3A and FIG. 3B and ink tanks 60 and 70 shown in FIGS. 5A-5E and FIGS. 6A-6E.

FIG. 5A is a perspective view showing a front surface and a bottom surface of the ink tank of the second embodiment of this invention. FIG. 5B is a front view of the ink tank, FIG. 5C is a bottom view of the ink tank, FIG. 5D is a vertical cross-sectional side view, and FIG. 5E is an enlarged cross-sectional view taken along the line VE-VE of FIG. 5C.

The ink tanks 60, 70 of this embodiment have outer structures similar to those of the ink tanks 30, 40 in the first embodiment. That is, the ink tank 60 shown in FIGS. 5A-5E has a plurality of partitioned ink accommodation portions 31a, 31b, 31c as with the ink tank 30 of FIGS. 1A-1C. At a bottom of each ink accommodation portion 31a, 31b, 31c is formed an ink supply port 35a, 35b, 35c. It is however noted that these ink supply ports 35a, 35b, 35c are formed at positions deviated to one side from centers C of respective bottom surfaces of the ink accommodation portions 31a, 31b, 31c, as shown in FIG. 5C.

Further, in the second embodiment, in the ink accommodation portions 31a, 31b, 31c there are installed not only ink holding members 34a, 34b, 34c but also ink draw-out members 61a, 61b, 61c at positions that close the ink supply ports 35. In the description that follows, these ink draw-out members may be generally represented by a reference number 61.

The ink draw-out members 61 are formed of a material having a higher ink absorbing capability than that of the ink holding members 34a, 34b, 34c. Thus, the ink draw-out members 61 allow the inks absorbed and held in the ink holding members 34a, 34b, 34c to be led easily to the ink supply ports 35. Further, in the second embodiment, the tank is provided with support members 62, 63 to support the ink holding members 34a, 34b, 34c installed in the ink accommodation portions 31a, 31b, 31c on their bottom side.

FIG. 5E is a cross section taken along the line VE-VE of FIG. 5C showing the support members 62, 63 provided in the two ink accommodation portions 31a, 31b. As shown in the figure, the support members 62, 63 are constructed of an inner surface of a wall portion that is formed with the notched portion 38 that fits over the raised portion 58, 59 of the tank holder 50. That is, the notched portion 38 is formed on almost the same line as the separation wall between the ink accommodation portions 31a, 31b. The inner surface of the wall portion formed with the notched portion 38 has an inwardly protruding portion at a lower part thereof. The inwardly protruding portion constitutes the support members 62, 63. Then the ink holding members 34a, 34b installed in the ink accommodation portions 31a, 31b are partially pressed and supported by side portions of the support members 62, 63.

In another ink accommodation portion 31c, a riblike support member 64 protrudes inwardly as shown in FIG. 5C. The ink holding member 34c installed in the ink accommodation portion 31c is supported by an upper surface of the support member 64.

FIG. 6A is a perspective view showing a front surface and a bottom surface of a single color ink tank 70 in the second embodiment of this invention. FIG. 6B is a front view, FIG. 6C is a bottom view, FIG. 6D is a vertical cross-sectional side view, and FIG. 6E is an enlarged cross-sectional view taken along the line VIE-VIE of FIG. 6C.

The ink tank 70 of this embodiment also has almost the same outer structure as that of the ink tank 40 of the first embodiment. That is, the ink tank 70 shown in FIGS. 6A-6E has an ink supply port 45 formed at a bottom of a single ink accommodation portion, as with the single color ink tank 40 shown in FIGS. 2A and 2B. It is noted however that the ink supply port 45 in this embodiment is situated at a position deviated to one side from a center C of the bottom of an ink accommodation portion 41a, as shown in FIG. 6C.

In the ink tank 70 there are provided not only an ink holding member 44 but also an ink draw-out member 71 at a position where it closes the ink supply port 45. The ink draw-out member 71 is formed of a material having a higher ink absorbing capability than that of the ink holding member 44. Thus, ink absorbed and held in the ink holding member 44 can be led easily to the ink supply port 45 by the ink draw-out member 71. Further, in the second embodiment, a support member 72 is provided to support the ink holding member 44 installed in the ink accommodation portion 41a on the bottom side.

FIG. 6E is a cross section taken along the line VIE-VIE of FIG. 6C illustrating the support member 72 provided in the ink accommodation portion 41a. As shown in the figure, the support member 72 is constructed of an inner surface of a wall portion that is formed with the notched portion 48 that fits over the raised portion 59 of the tank holder 50. That is, the inner surface of the wall portion formed with the notched portion 48 protrudes inwardly of the ink accommodation portion 41a to form the support member 72. The ink holding member 44 accommodated in the ink accommodation portion 41a is supported from below by an upper surface of the protruding portion, as shown in FIG. 6E. The support member 72, as shown in FIG. 6D, compressively supports the ink holding member 44 even when the ink tank is not installed in the tank holder.

With an ink cartridge using the ink tank of the above construction, it is possible, as in the first embodiment, to decide whether or not the ink tank 60, 70 being installed is an intended one according to whether the notched portion 38, 48 formed in the back surface of the ink tank 60, 70 snugly accepts the raised portion 58, 59 formed in the tank holder 50. Further, in this embodiment, since the ink holding members 34, 44 in the ink tank 60, 70 are supported by the support members 62-64, 72, the ink holding members 33, 34 can be prevented from being rotated or shifted in the tank case 32, 42, allowing the inks accommodated therein to be led reliably to the ink supply ports 35, 45.

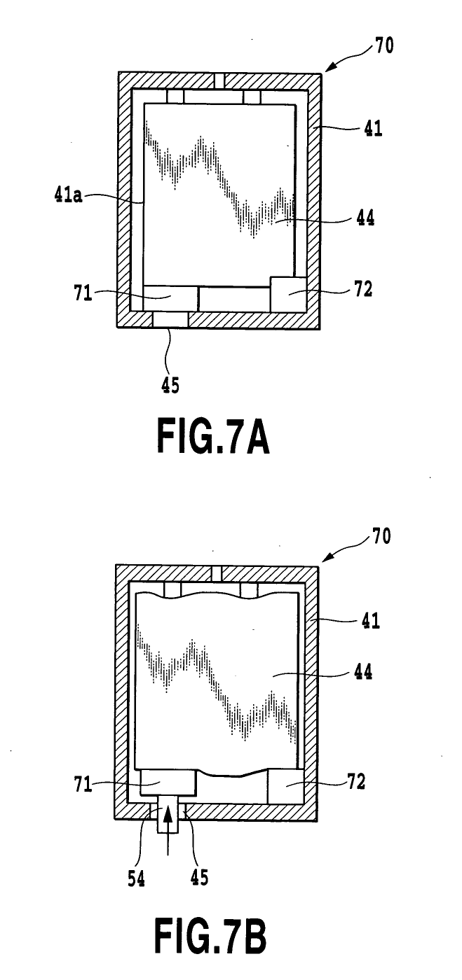

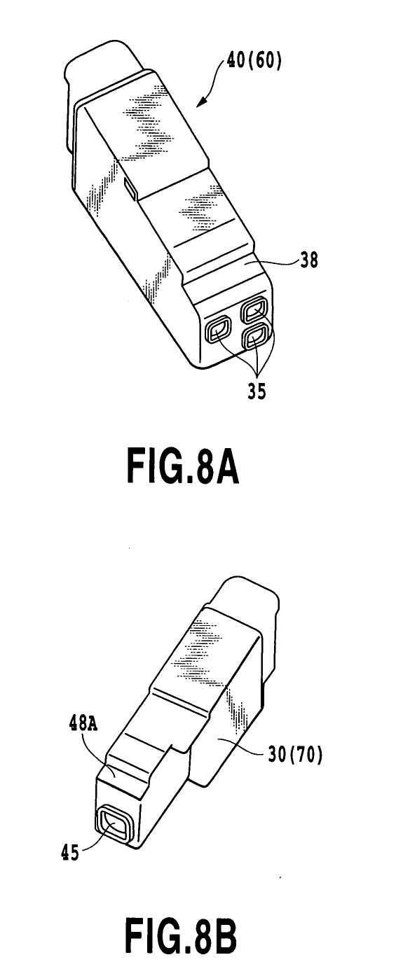

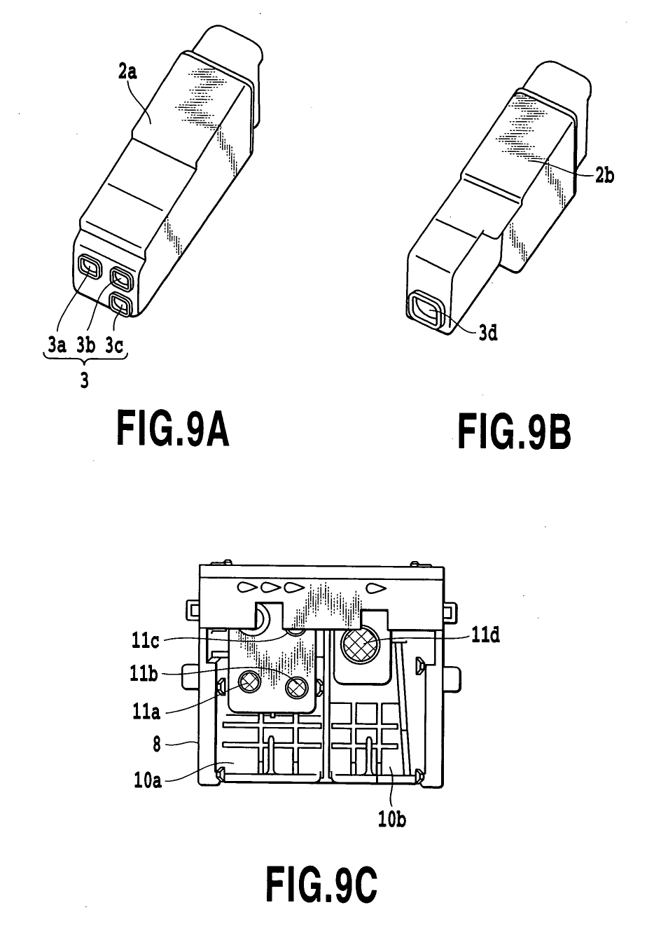

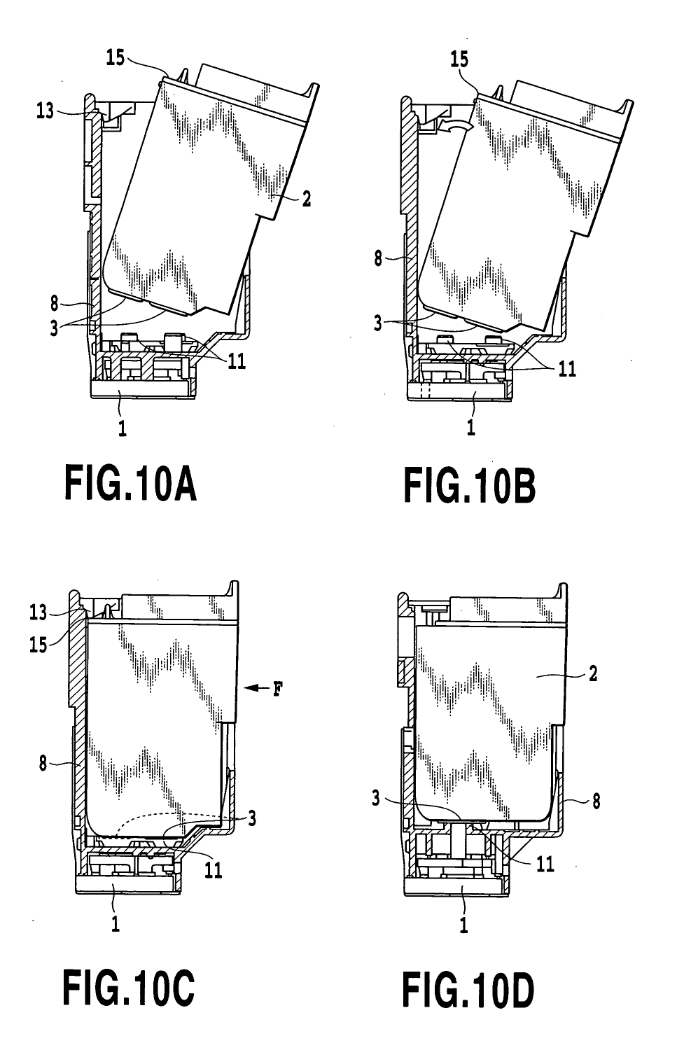

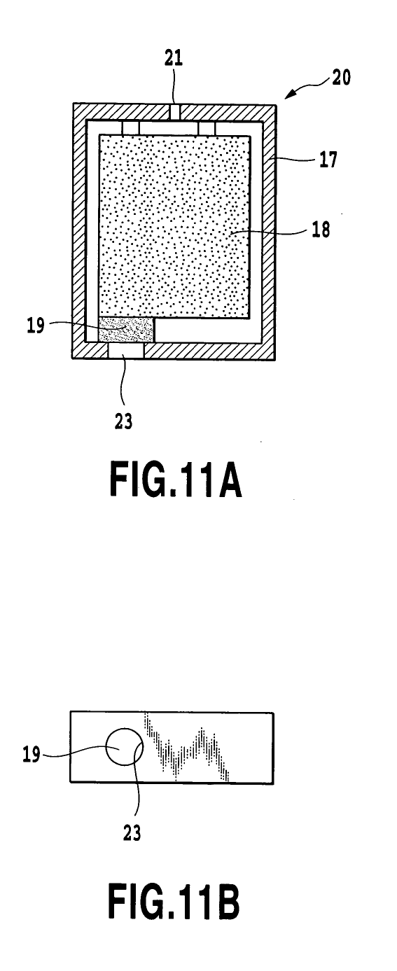

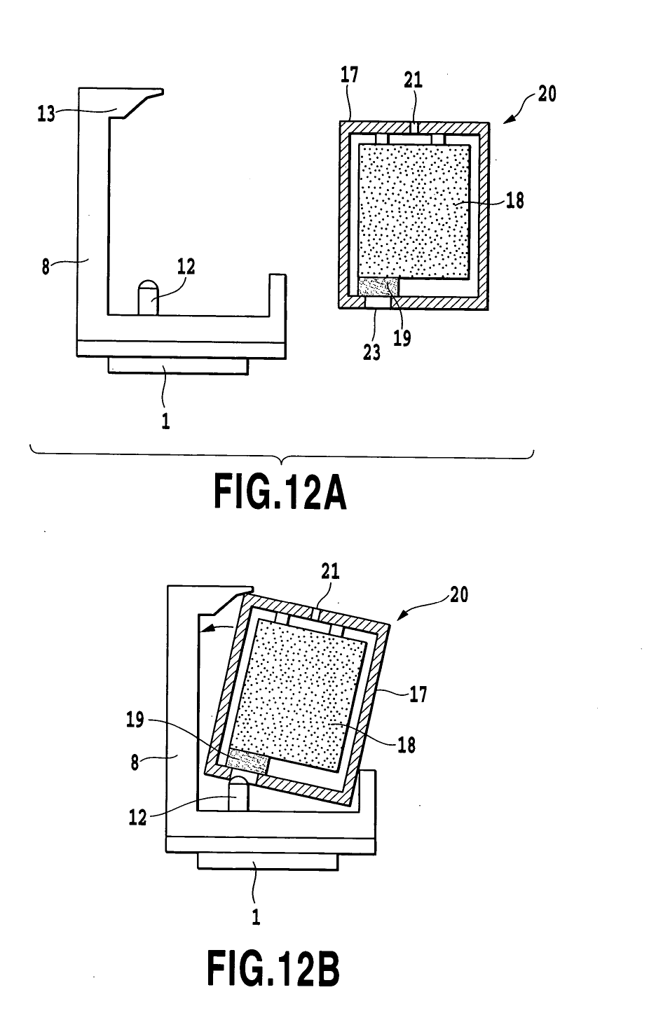

FIG. 7A and FIG. 7B show a state of the ink holding member 44 before the ink tank 70 is installed into the tank holder 50 and a state of the ink holding member 44 after the ink tank 70 has been installed into the tank holder 50.

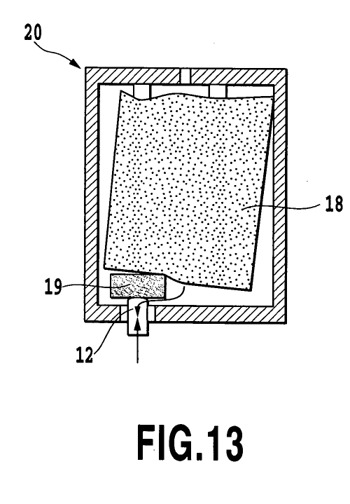

As shown in FIG. 7B, when the ink tank 70 has been installed into the tank mounting portion, the ink introduction member 54 protrude through the ink supply port 45 upward into the ink tank 70 to push the ink holding member 44 through the ink draw-out member 71. Since the ink supply port 45 is deviated from the center of the bottom of the ink accommodation portion 41a toward the back, the ink holding member 44 is pushed at a position deviated from the center of its bottom by the ink introduction member 54, protruding from the ink supply port 45, through the ink draw-out member 71. If the support member 72 were not provided, the ink holding member 44 would be rotated as in the conventional tank of FIG. 13, with a result that the contact between the ink introduction member 71 and the ink holding member 44 may become uneven or partial. However, in this embodiment, the support member 72 provided on the front side of the ink accommodation portion 41a supports the ink holding member 44 to prevent it from being rotated, thus ensuring that the bottom of the ink holding member 44 is uniformly deformed to engage the entire surface of the ink introduction member 71 uniformly. Therefore, even when a fast printing that requires a supply of large ink volume is performed, the ink supply from the ink holding member 44 to the ink introduction member 54 is properly executed, supplying a sufficient amount of ink to the print head which in turn can form an image in good condition.

Like the single color ink tank 70, whose installation into the tank holder 50 has been described, the multicolor ink tank 60 also has support members 62, 63, 64 at positions symmetric to the ink supply ports 35a, 35b, 35c with respect to centers of the bottom surfaces of the ink accommodation portions 31a, 31b, 31c. Thus, in the multicolor ink tank 60, too, the ink holding members 34a, 34b, 34c can be prevented from being rotated, realizing a good ink supply.

In the above embodiments, the notched portion 38, 48 is formed in a groove shape in a part of the front surface of the ink tank so that the ink tank, as it is installed, can be guided by the engagement between the notched portion and the raised portion of the tank holder. Further, it is possible to provide a plurality of kinds of erroneous mounting check patterns as by forming a plurality of raised portions in the tank holder and a plurality of corresponding notched portions in the ink tank. Further, for only an erroneous mounting prevention, the notched portion 38A, 48A may be formed over an entire width of the ink tank 40 (60), 30 (70), and the shape and position of the notched portion may be changed as required.

In the above description, an example case has been taken up in which the engaged portion formed in the ink tank is provided in the form of a notched portion and the engaging portion formed in the tank holder is provided in the form of a raised portion. It is noted however that the present invention is not limited to the above embodiment.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

What is claimed is:

1. An ink tank to be installed into a tank holder, wherein the tank holder has an ink tank mounting portion, an ink introduction portion arranged in a bottom surface of the ink tank mounting portion and communicating with an ink jet print head, and a raised portion protruding from the bottom surface of the ink tank mounting portion;
the ink tank comprising:
an ink supply port arranged in a bottom surface of the ink tank for drawing out ink; and
a notched portion arranged at a front edge portion of the bottom surface of the ink tank, communicating to the bottom surface and a front surface of the ink tank, and corresponding to the raised portion of the tank holder;
wherein the ink tank is mounted onto the tank holder, with the front edge portion of the bottom surface of the ink tank working as roughly a pivotal center.

2. An ink tank according to claim 1, wherein the tank holder has a plurality of kinds of ink tank mounting portions on which to mount a plurality of kinds of ink tanks and raised portions formed in specific shapes or at specific positions for the ink tank mounting portions;
wherein the ink tank has a notched portion that matches the raised portion only when the ink tank correctly matches the ink tank mounting portion into which it is being installed.

3. An ink tank according to claim 2, wherein a plurality of ink accommodation portions are defined in a single ink tank to accommodate a plurality of kinds of inks and an ink supply portion is formed in each of the ink accommodation portions;
wherein the tank holder has at least one tank mounting portion on which to removably mount the ink tank accommodating the plurality of kinds of inks;
wherein the ink tank has a single notched portion that matches only a single raised portion formed in the tank holder.

4. An ink tank according to any one of claims 1 to 3, wherein the notched portion is formed in a range narrower than a width of the ink tank.

5. An ink tank according to any one of claims 1 to 3, wherein the notched portion is formed over an entire width of the ink tank.

6. An ink tank according to any one of claims 1 to 3, wherein the ink tank has on its side surface a memory device storing information on the ink tank and a contact led out from the memory device;
wherein, during a process of mounting the ink tank onto the ink tank holder, the contact comes into electrical contact with a connector on the ink tank holder only when or immediately before the ink tank moves to a tank mounting position.

7. An ink tank according to any one of claims 1 to 3, wherein the ink accommodation portion includes:
the ink supply port provided at a position deviated from a center of a bottom thereof to one side;
an ink holding member to absorb and hold ink;
an ink draw-out member arranged between the ink supply port and the ink holding member; and
a support member formed at a position deviated from the center of the bottom to the opposite side to compressively support the ink holding member.

8. An ink tank according to claim 7, wherein the support member is in compressive contact with the ink holding member even when the ink tank is not mounted on the ink jet print head.

9. An ink tank according to claim 8, wherein the notched portion is formed by inwardly recessing a bottom of the ink tank and by forming a protrusion protruding inwardly from an inner surface of the ink tank;
wherein the protrusion forms the support member to support the ink holding member.
